(19) United States
(12) Patent Application Publication
(10) Pub. No.: US 2009/0056161 A1
(43) Pub. Date: Mar. 5, 2009

(54) DUCTLESS TYPE CLOTHES DRIER

(76) Inventors: Seung-Phyo AHN, Changwon (KR); Byeong-Jo Ryoo, Changwon (KR); Sung-Ho Song, Changwon (KR); Yang-Hwan Kim, Changwon (KR); Yoon-Seob Eom, Changwon (KR); Yang-Ho Kim, Changwon (KR); Jae-Hyuk Wee, Changwon (KR)

Correspondence Address: KED & ASSOCIATES, LLP, P.O. Box 221200, Chantilly, VA, 20153-1200, US

(21) Appl. No.: 12/203,459

(22) Filed: Sep. 3, 2008

(30) Foreign Application Priority Data
Sep. 4, 2007 (KR) 10-2007-0089673

(51) Int. Cl. F26B 21/06; F26B 11/02; F27D 11/00

(52) U.S. Cl. 34/79; 34/595; 219/385

(57) ABSTRACT

A ductless type clothes drier comprises a dew condensation preventing cover configured to remove moisture included in finally exhausted air discharged to a wall surface behind a body via the heat exchanger. Accordingly, finally exhausted air including moisture is prevented from directly contacting a wall surface, thereby preventing dew condensation phenomenon occurring as moisture included therein is condensed on the wall surface. As a result, can be solved the conventional problem that stains or fungi are reproduced on the wall surface thus to cause appearance degradation and sanitary problems.

### RELATED APPLICATION

The present invention relates to subject matter contained in priority Korean Application No. 10-2007-0089673, filed on Sep. 4, 2007, which is herein expressly incorporated by reference in its entirety.

### BACKGROUND OF THE INVENTION

1. Field of the Invention

The present invention relates to a ductless type clothes drier.

2. Description of the Background Art

Generally, a clothes drier serves to dry clothes by blowing hot air into a drum and thereby absorbing moisture inside the clothes. The clothes drier may be largely classified into an exhausting type and a condensing type according to a method for processing air occurring when clothes are dried.

In the exhausting type clothes drier, a method for exhausting humid air discharged from a drum is used. An exhaustion duct for exhausting moisture evaporated from the drum is required. Furthermore, since carbon monoxide, etc., a byproduct after combustion is exhausted, the exhaustion duct has to be long extending up to outdoors.

In the condensing type clothes drier, humid air discharged from a drum is condensed by a heat exchanger thus to have moisture removed therefrom. Then, the air including moisture removed therefrom is re-introduced into the drum thus to be recycled. However, since the dried air flows with a closed loop, it is not easy to use gas as a heat source.

To overcome the disadvantages of the exhausting type clothes drier and the condensing type clothes drier, there is provided a ductless type clothes drier. The ductless type clothes drier can be maintained with a low cost since gas is used as a heat source. Furthermore, in the ductless type clothes drier, an exhaustion duct long-extending to outdoors does not have to be installed.

In the ductless type clothes drier, finally exhausted air is directly discharged through an exhaust port disposed at a rear side thereof. Here, the ductless type clothes dries is installed so that an exhaust port is adjacent to a wall surface, and finally exhausted air comes in contact with the wall surface for a long time. As a result, partial dew condensation occurs.

When finally exhausted air comes in continuous contact with the wall surface, moisture inside the exhausted air is condensed on the cool wall surface thus to form water drops. As a result, stains or fungi are reproduced on the wall surface, which causes appearance degradation and sanitary problems.

### SUMMARY OF THE INVENTION

Therefore, it is an object of the present invention to provide a ductless type clothes drier capable of preventing partial dew condensation occurring as finally exhausted air is condensed on a wall surface.

To achieve these and other advantages and in accordance with the purpose of the present invention, as embodied and broadly described herein, there is provided a ductless type clothes drier, comprising: a body installed at a wall surface, and having an exhaust port toward the wall surface; and a dew condensation preventing cover configured to prevent air discharged from the exhaust port from directly contacting the wall surface.

Preferably, the dew condensation preventing cover may be installed at a rear side of the body, or near the exhaust port with a predetermined distance from the exhaust port.

Preferably, the dew condensation preventing cover may be an open type cover configured to convert a moving direction of air so that the air discharged from the exhaust port can be prevented from directly contacting the wall surface. Also, the dew condensation preventing cover may be a close type cover configured to convert a moving direction of air so that the air discharged from the exhaust port can be prevented from directly contacting the wall surface, and configured to have a space where air stays for a predetermined time.

Preferably, the close type cover may be further provided with a dehumidifying element configured to remove humidity included in air which stays in the space, or a thermoelectric element.

Preferably, the thermoelectric element may receive power supplied to the body, or receive power from a primary cell or a secondary cell.

To achieve these and other advantages and in accordance with the purpose of the present invention, as embodied and broadly described herein, there is also provided a ductless type clothes drier, comprising: a body; a drum rotatably installed at the body; a hot air supply unit configured to supply hot air into the drum; a heat exchanger configured to remove moisture included in air exhausted from the drum; and a dew condensation preventing cover configured to remove moisture included in finally exhausted air discharged to a wall surface behind the body via the heat exchanger.

Preferably, the dew condensation preventing cover may be configured to dehumidify finally exhausted air, and then to exhaust the dehumidified air to upper and lower directions and/or side directions in a distributed manner.

Preferably, the ductless type clothes drier further comprises an exhaust duct having one end connected to the heat exchanger, and another end exposed to a rear side of the body. Preferably, the dew condensation preventing cover may be implemented as an open type cover configured to dehumidify finally exhausted air discharged from an exhaust port of the exhaust duct, and then to exhaust the dehumidified air to an upper direction and both side directions in a distributed manner.

Preferably, the dew condensation preventing cover may include a front surface portion facing the exhaust port with a predetermined distance therefrom, and a fixing portion configured to fix the front surface portion to the body. Preferably, a dehumidifying element or a thermoelectric element may be mounted to the front surface portion.

Preferably, the ductless type clothes drier further comprises an exhaust duct having one end connected to the heat exchanger, and another end exposed to a rear side of the body. Preferably, the dew condensation preventing cover may be implemented as an open type cover configured to dehumidify finally exhausted air discharged from an exhaust port of the exhaust duct, and then to exhaust the dehumidified air.

Preferably, the dew condensation preventing cover may include a vessel portion configured to temporarily store finally exhausted air, and having slits through which air is exhausted to both side surfaces and/or upper and lower surfaces; and a fixing portion configured to fix the vessel portion to the body. Preferably, a dehumidifying element or a thermoelectric element may be mounted to the front surface portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of a ductless type clothes drier according to a first embodiment of the present invention;

FIG. 2 is a side sectional view of the ductless type clothes drier of FIG. 1, which shows that an exhaust port of the ductless type clothes drier is installed near a wall surface;

FIG. 3 is a plane sectional view of the ductless type clothes drier of FIG. 1;

FIG. 4 is a perspective view of a dew condensation preventing cover of FIG. 1; and

FIG. 5 is a modification example of the dew condensation preventing cover of FIG. 4.

### DETAILED DESCRIPTION OF THE INVENTION

Reference will now be made in detail to the preferred embodiments of the present invention, examples of which are illustrated in the accompanying drawings.

Hereinafter, a ductless type clothes drier according to a first embodiment of the present invention will be explained in more detail with reference to the attached drawings.

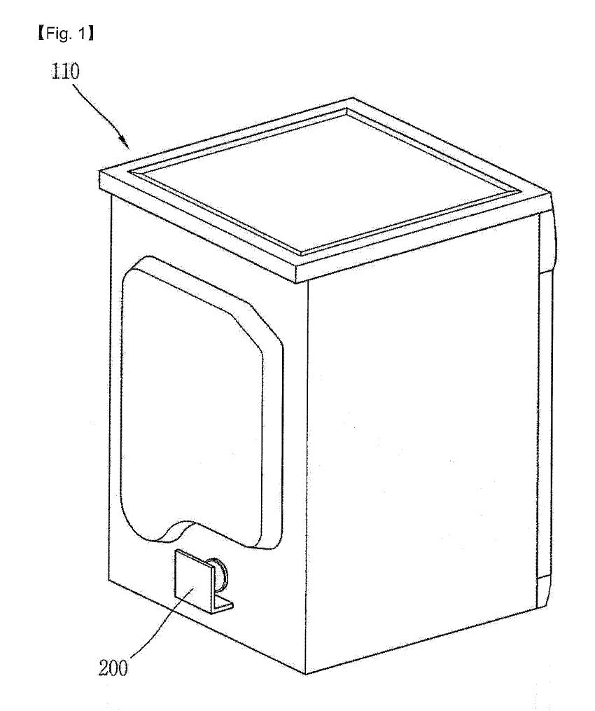

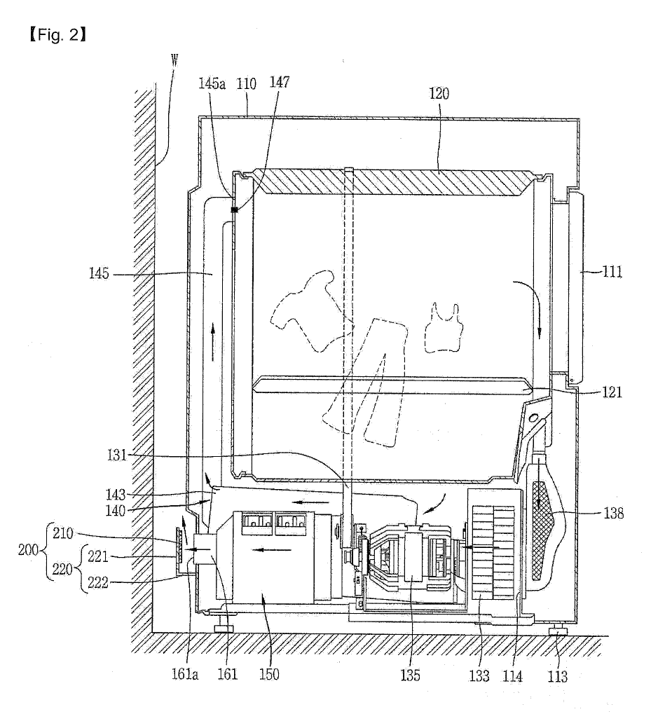

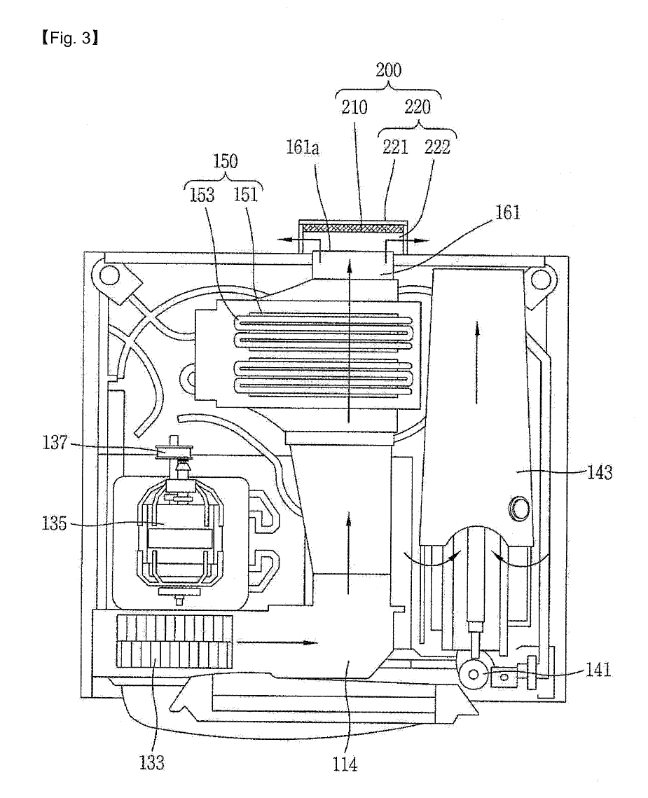

FIG. 1 is a perspective view of a ductless type clothes drier according to a first embodiment of the present invention; FIG. 2 is a side sectional view of the ductless type clothes drier of FIG. 1, which shows that an exhaust port of the ductless type clothes drier is installed near a wall surface; and FIG. 3 is a plane sectional view of the ductless type clothes drier of FIG. 1.

Referring to FIGS. 1 and 2, the ductless type clothes drier according to a first embodiment of the present invention comprises: a body 110; a drum 120 rotatably installed at the body 110; a hot air supply unit 140 configured to supply hot air into the drum 120; a heat exchanger 150 configured to remove moisture included in air exhausted from the drum 120; and a dew condensation preventing cover 200 configured to remove moisture included in finally exhausted air discharged to a wall surface (W) behind the body 110 via the heat exchanger 150.

Referring to FIGS. 2 and 3, a door 111 through which clothes are introduced into the drum 120 is installed on a front surface of the body 110, and a foot 113 configured to support the body 110 is installed below the body 110. Inside the body 110, installed are a belt 131 configured to rotate the drum 120, a fan 133 disposed inside a circulation duct 114 that provides a blowing force by air inside the clothes, and a motor 135 configured to provide a driving force to the belt 131 and the fan 133. A pulley 137 configured to lock the belt 131 is installed on a rotation shaft of the motor 135. Here, the motor 135 may be configured in plurality in number so that a driving force can be provided to the belt 131 and the fan 133, respectively.

At the circulation duct 114, installed is a filter 138 configured to filter lint such as nap or seam included in high temperature and high humid air exhausted from the drum 120.

The drum 120 is a box having an inner space to which an object to be dried, such as clothes, is introduced, and is provided with a plurality of lifters 121 therein configured to lift clothes.

The hot air supply unit 140 includes a gas valve 141 configured to supply gas and shield gas supply, a gas combustor 143 configured to generate hot air by mixing gas exhausted from the gas valve 141 with external air and then by igniting the mixed air, a hot air supply duct 145 configured to connect the gas combustor 143 and the drum 120 to each other so that the generated hot air can be supplied to the drum 120, and a hot air temperature sensor 147 configured to detect a temperature of hot air introduced into the drum 120.

At the hot air supply unit 140, may be installed a flame rod (not shown) extending from an edge of flame so as to detect a flame current and thus to indirectly judge an occurrence amount of carbon monoxide (CO) through a value of the flame current.

Based on a flame current measured by the flame rod, a controller (not shown) judges an occurrence amount of carbon monoxide (CO). Here, if the occurrence amount of carbon monoxide is increased enough to be harmful to a human body, gas supply is shielded and an alarm sound rings.

The gas combustor 143 is connected to the gas valve 141, thereby mixing gas exhausted from the gas valve 141 with external air and combusting the mixed gas. Then, generated heated is used to heat air.

Hot air generated by heating air is provided to the drum 120 through the hot air supply duct 145.

The hot air temperature sensor 147 is installed at a connection part 145a between the hot air supply duct 145 and the drum 120. The hot air temperature sensor 147 may be installed in plurality in number, and may be installed in the hot air supply duct 145.

If a temperature of air detected by the hot air temperature sensor 147 exceeds a reference temperature (a reference temperature to prevent damage of clothes or to prevent fire occurrence) in the case of the followings, clothes damage occurs. A first case is that air flow is not smooth as lint is introduced into the filter 138. A second case is that air flow is not smooth due to too large amount of clothes inside the drum. A third case is that a duct connected to outside is blocked thus to decrease an air volume inside the ductless type clothes drier.

To prevent the above cases, the hot air supply unit 140 controls an amount of gas supplied to the gas combustor 143 by controlling the gas valve 141 according to an air volume. More concretely, when an air volume is decreased to cause a temperature detected by the hot air temperature sensor 147 to exceed a reference temperature, the gas valve 141 is partially or completely closed. Accordingly, an amount of gas supplied to the gas combustor 143 is decreased, or gas is prevented from being introduced into the gas combustor 143. Preferably, the gas valve 141 is implemented as a solenoid valve so as to sensitively adjust a gas injection amount. Consequently, air temperature can be lowered by reducing an amount of heat supplied to air introduced into the drum 120 without frequently stopping gas combustion. Accordingly, clothes are prevented from being damaged, and the clothes drier has an enhanced stability.

The heat exchanger 150 is composed of fins 151 and tubes 153. High temperature and high humidity air exhausted from the drum 120 is condensed by low temperature water in a heat exchange manner between air and water, thereby being in a dried state. An inlet of the heat exchanger 150 is connected to the drum 120 by the circulation duct, and an outlet thereof is connected to an exhaust duct 161.

The fins 151 are implemented as a plurality of metallic thin plates having an excellent conductivity are laminated to each other with a minute gap therebetween so as to vertically contact and pass high temperature and high humid air.

The tubes 153 have water of a low temperature (22° C.) circulating therein, and penetrate the fins 151 in a zigzag manner. A water hose (not shown) configured to supply low temperature water and collect the supplied water is connected to both ends of the tubes 153. A water tank (not shown) configured to collect condensing water generated during a condensation process and then dropping is disposed below the heat exchanger 150.

The dew condensation preventing cover 200 serves to remove moisture included in air having not been dehumidified by the heat exchanger 150. That is, the dew condensation preventing cover 200 dehumidifies finally exhausted air discharged from an exhaust port 161a of the exhaust duct 161. As indicated by the arrows of FIGS. 1 and 2, the dew condensation preventing cover 200 discharged the finally exhausted air to an upper direction and/or both side directions of a rear surface of the body 110 in a distributed manner.

Accordingly, finally exhausted air including moisture is prevented from directly contacting the wall surface (W), thereby preventing dew condensation phenomenon occurring as moisture included therein is condensed on the wall surface. As a result, can be solved the conventional problem that stains or fungi are reproduced on the wall surface thus to cause appearance degradation and sanitary problems.

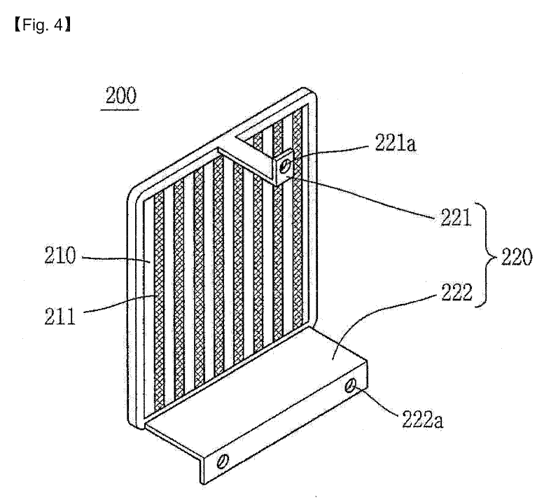

Referring to FIGS. 3 and 4, the dew condensation preventing cover 200 is an open type cover having an upper side and both sides thereof opened. The dew condensation preventing cover 200 includes a front surface portion 210 facing the exhaust port 161a with a predetermined distance therefrom, and a fixing portion 220 configured to fix the front surface portion 210 to the body 110.

The front surface portion 210 is a part to which air exhausted from the exhaust port 161a firstly contacts. A dehumidifying element 211 configured to remove moisture included in air is installed at the front surface portion 210.

The dehumidifying element 211 absorbs moisture included in finally exhausted air, and evaporates the contained moisture when the ductless type clothes drier is not used. As the dehumidifying element 211 evaporates moisture, the dehumidifying element 211 returns to the original state.

As disclosed in U.S. Pat. No. 5,683,532, the dehumidifying element 211 is obtained by impregnating a sheet or a honey-comb shaped ceramic carrier in a water glass and semi-drying it, then by impregnating it into an acid solution such as sulfuric acid or hydrochlroric acid thereby solidifying silica hydrogel in the ceramic carrier, and then washing the solidified silica hydrogel and drying it. The dehumidifying element 211 may be also formed by methods disclosed in Japanese Patent Publication No. 63-175619, Korean Patent Publication No. 10-2004-88762, etc.

Instead of the dehumidifying element 211, a thermoelectric element configured to remove moisture included in finally exhausted air may be installed at the dew condensation preventing cover 200.

The thermoelectric element is formed by connecting two ends of two kinds of metal to each other. Once a current is applied to the thermoelectric element, one side of the thermoelectric element absorbs heat in a current direction, and another side thereof emits heat. Here, the thermoelectric element is installed at the dew condensation preventing cover 200 so that the heat emitting portion can be toward the exhaust port.

Under this configuration, moisture included in finally exhausted air comes in contact with the heat emitting portion to be evaporated.

The thermoelectric element may be formed by using semiconductor devices such as Bi and Te having different conductivity rather than the two kinds of metal. Here, a heat absorbing function and a heat emitting function can be converted to each other according to a current direction, and a heat absorbing amount and a heat emitting amount can be controlled according to a current amount.

In order to supply a current to the thermoelectric element, a primary cell or a secondary cell may be installed at the dew condensation preventing cover 200. In another way, power received from the body 110 may be supplied to the thermoelectric element.

The fixing portion 220 is composed of an upper end supporter 221 formed at an upper side of the front surface portion 210, and a lower end supporter 222 formed at a lower side of the front surface portion 210. The fixing portion 220 may be composed of only the lower end supporter 222. Slits through which air is discharged may be formed at the lower end supporter 222, so that finally exhausted air exhausted from the exhaust port 161a can be discharged to a lower side of a rear surface of the body 110.

Through holes 221a and 222a configured to allow screws to penetrate thereinto are formed at the upper end supporter 221 and the lower end supporter 222, respectively. As screws are coupled to the body 110 via the through holes 221a and 222a, the dew condensation preventing cover 200 is coupled to the body 110.

Referring to FIGS. 2 and 3, owing to the dew condensation preventing cover 200 having the dehumidifying element 211 mounted thereto, even if the ductless type clothes drier is installed near a wall surface so that the exhaust port 161a installed at a rear side of the ductless type clothes drier can be toward the wall surface, dew condensation does not occur. That is, air exhausted from the exhaust port 161a is discharged to an upper direction or side directions of the rear surface of the body 110 in a distributed manner, which is indicated by the arrow. At the same time, moisture included in finally exhausted air is removed. Accordingly, finally exhausted air including moisture therein is prevented from directly contacting a wall surface, thereby solving the conventional problem that stains or fungi are reproduced on the wall surface thus to cause appearance degradation and sanitary problems.

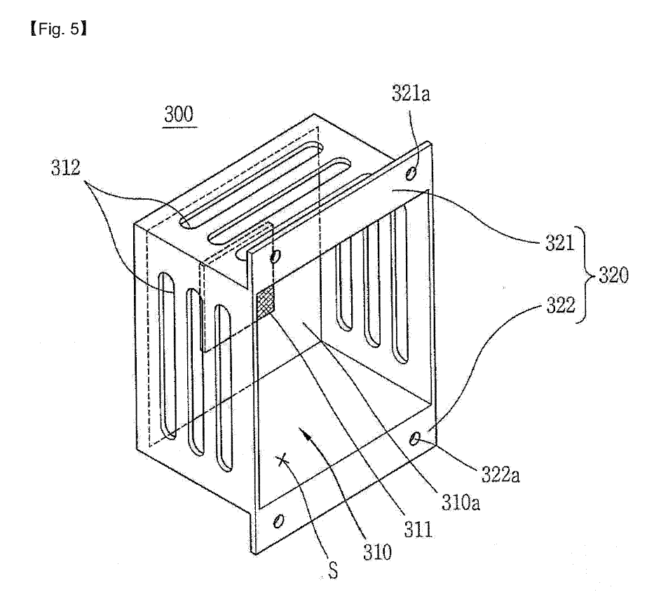

FIG. 5 is a modification example of the dew condensation preventing cover of FIG. 4.

Referring to FIG. 5, a dew condensation preventing cover 300 is a closed type cover that collects to dehumidify finally exhausted air discharged from the exhaust port 161a, and then exhausts the dehumidified air through slits 312. The dew condensation preventing cover 200 may include a vessel portion 310 configured to temporarily store finally exhausted air, and having slits 312 through which air is exhausted to both side surfaces and/or an upper surface; and a fixing portion 320 configured to fix the vessel portion 310 to the body 110.

The vessel portion 310 forms a space (S) to temporarily store finally exhausted air discharged from the exhaust port 161a. A dehumidifying element 311 configured to remove moisture inside air is installed at a bottom surface 310a of the vessel portion 310. Since the dew condensation preventing cover 300 is a closed type cover, a dehumidifying process can be performed while air is collected. Accordingly, the dehumidifying element 311 may be installed at any part inside the vessel portion 310.

The dehumidifying element 311 absorbs moisture included in finally exhausted air, and evaporates the contained moisture when the ductless type clothes drier is not used. As the dehumidifying element 311 evaporates moisture, the dehumidifying element 211 returns to the original state. A method for manufacturing the dehumidifying element was aforementioned, and thus its detailed explanation will be omitted.

The fixing portion 320 is composed of an upper edge 321 formed along an outer periphery of the vessel portion 310, and a lower edge 322. Through holes 321a and 322a configured to allow screws to penetrate thereinto are formed at the upper edge 321 and the lower edge 322, respectively. As screws are coupled to the body 110 via the through holes 321a and 322a, the dew condensation preventing cover 200 is coupled to the body 110.

Even if the ductless type clothes drier is installed near a wall surface so that the exhaust port 161a (refer to FIG. 1) installed at a rear side of the ductless type clothes drier can be toward the wall surface, dew condensation does not occur owing to the dew condensation preventing cover 300 having the dehumidifying element 311 mounted thereto. That is, air exhausted from the exhaust port 161a is discharged to an upper direction or side directions of the rear surface of the body 110 through the slits 312 in a distributed manner, which is indicated by the arrow. At the same time, moisture included in finally exhausted air is removed. Accordingly, finally exhausted air including moisture therein is prevented from directly contacting a wall surface, thereby solving the conventional problem that stains or fungi are reproduced on the wall surface thus to cause appearance degradation and sanitary problems. Since the dew condensation preventing cover 300 is a closed type cover, a dehumidifying process can be performed while air is collected. Accordingly, dehumidifying time is increased thus to enhance dehumidifying efficiency.

As aforementioned, the ductless type clothes drier comprises the dew condensation preventing cover configured to remove moisture included in finally exhausted air discharged to a wall surface behind the body via the heat exchanger. Accordingly, finally exhausted air is prevented from directly contacting the wall surface, thereby preventing dew condensation phenomenon occurring as moisture included therein is condensed on the wall surface. As a result, can be solved the conventional problem that stains or fungi are reproduced on the wall surface thus to cause appearance degradation and sanitary problems.

The foregoing embodiments and advantages are merely exemplary and are not to be construed as limiting the present invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A ductless type clothes drier, comprising:
a body installed at a wall surface, and having an exhaust port toward the wall surface; and
a dew condensation preventing cover configured to prevent air discharged from the exhaust port from directly contacting the wall surface.

2. The ductless type clothes drier of claim 1, wherein the dew condensation preventing cover is installed at a rear side of the body.

3. The ductless type clothes drier of claim 1, wherein the dew condensation preventing cover is installed near the exhaust port with a predetermined distance from the exhaust port.

4. The ductless type clothes drier of claim 1, wherein the dew condensation preventing cover is an open type cover configured to convert a moving direction of air so that the air discharged from the exhaust port can be prevented from directly contacting the wall surface.

5. The ductless type clothes drier of claim 1, wherein the dew condensation preventing cover is a close type cover configured to convert a moving direction of air so that the air discharged from the exhaust port can be prevented from directly contacting the wall surface, and configured to have a space where air stays for a predetermined time.

6. The ductless type clothes drier of claim 5, wherein the close type cover further includes a dehumidifying element configured to remove humidity included in the air which currently stays in the space.

7. The ductless type clothes drier of claim 5, wherein the close type cover further includes a thermoelectric element configured to remove humidity included in air which currently stays in the space.

8. The ductless type clothes drier of claim 7, wherein the thermoelectric element receives power supplied to the body.

9. The ductless type clothes drier of claim 7, wherein the thermoelectric element receives power from a primary cell or a secondary cell.

10. A ductless type clothes drier, comprising:
a body;
a drum rotatably installed at the body;
a hot air supply unit configured to supply hot air into the drum;
a heat exchanger configured to remove moisture included in air discharged from the drum; and
a dew condensation preventing cover configured to remove moisture included in finally exhausted air discharged to a wall surface behind the body via the heat exchanger.

11. The ductless type clothes drier of claim 10, wherein the dew condensation preventing cover is configured to dehumidify finally exhausted air, and then to exhaust the dehumidified air to upper and lower directions and/or side directions in a distributed manner.

12. The ductless type clothes drier of claim 10, further comprising:
an exhaust duct having one end connected to the heat exchanger, and another end exposed to a rear side of the body,
wherein the dew condensation preventing cover is implemented as an open type cover configured to dehumidify finally exhausted air discharged from an exhaust port of the exhaust duct, and then to exhaust the dehumidified air to an upper direction and both side directions in a distributed manner.

13. The ductless type clothes drier of claim 12, wherein the dew condensation preventing cover includes:
a front surface portion facing the exhaust port with a predetermined distance therefrom; and
a fixing portion configured to fix the front surface portion to the body.

14. The ductless type clothes drier of claim 10, further comprising an exhaust duct having one end connected to the heat exchanger, and another end exposed to a rear side of the body,
wherein the dew condensation preventing cover is implemented as a closed type cover that collects to dehumidify finally exhausted air discharged from the exhaust port, and then exhausts the dehumidified air.

15. The ductless type clothes drier of claim 14, wherein the dew condensation preventing cover includes:
a vessel portion configured to temporarily store finally exhausted air, and having slits through which air is exhausted to both side surfaces and/or upper and lower surfaces; and
a fixing portion configured to fix the vessel portion to the body.

16. The ductless type clothes drier of claim 15, wherein a dehumidifying element or a thermoelectric element is installed at the vessel portion.
